(19) United States
(12) Patent Application Publication
(10) Pub. No.: US 2011/0015366 A1
(43) Pub. Date: Jan. 20, 2011

(54) NOVEL CHAIN EXTENDERS FOR POLYURETHANE ELASTOMER FORMULATIONS

(76) Inventors: Georges Da Costa, Saix (FR); Herve Rolland, Castres (FR); Daniel Muller, Saint-Maur (FR)

Correspondence Address: YOUNG & THOMPSON, 209 Madison Street, Suite 500, Alexandria, VA, 22314, US

(21) Appl. No.: 12/867,905

(22) PCT Filed: Jan. 20, 2009
(86) PCT No.: PCT/FR09/50073

§ 371 Date: Aug. 17, 2010

(30) Foreign Application Priority Data
Feb. 25, 2008 (FR) 0851171

(51) Int. Cl. C08G 18/77; C09K 3/00; C08G 65/38

(52) U.S. Cl. 528/73; 252/182.27; 528/219

(57) ABSTRACT

A composition that includes: a compound of the formula (I) in which R₁, R₂, R₃ and R₄ are identical or different and represent, independently from each other, a hydrogen atom, a methyl radical or an ethyl radical, A and B are identical or different and represent, independently from each other, a number between 0 and 10 with the proviso that the sum of A+B is higher than zero; and a compound of formula (II).

The invention falls within the field of elastomer production. In particular, the invention relates to mixtures of isosorbide and diethoxylated bisphenol A as chain extenders in the field of elastomers, and more particularly polyurethane elastomers. Chain extenders are at least difunctional compounds.

The preparation of elastomer polymers often employs chain extender compounds that have the function of improving certain physical properties of the final polymer, such as its hardness, its thermal resistance or its hydrolysis resistance.

The chain extenders most often used in the preparation of polyurethane elastomers are 1,4-butanediol or BDO:

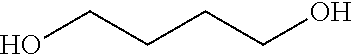

1,4-bis(2-hydroxyethoxy)benzene or HQEE:

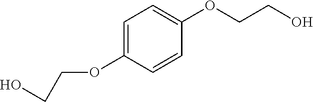

or diethoxylated resorcinol or HER:

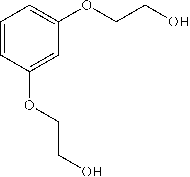

The use of HQEE or HER, as opposed to 1,4-butanediol, gives the elastomer greater hardness through the geometry of the molecule, but also better thermal and hydrolysis resistance.

Despite the good mechanical performance that it provides, 1,4-butanediol nevertheless suffers from drawbacks in certain applications. For example it results in opaque products and is not based on renewable raw materials.

The preparation and use of an HER/Dianol 220 (i.e. diethoxylated bisphenol A) mixture as chain extender are described in patent application EP 1 496 074.

The advantages of using HER as chain extender in polyurethanes are clearly indicated in the Indspec Chemical Corp. publications: “Lower-durometer HER-extended plasticizer-free TDI elastomers”, PMA-CUMA Meeting, Toronto (Canada), 4-6 Nov. 2001; “HER Technical Bulletin”, August 1997; and “HER Technical Bulletin”, UTECH 2000, March 2000.

The examples described in patent application US 2006/0293486 describe 1,4-butanediol as chain extender.

The novelty of using diamines or diimines as chain extenders in the polyurethane field is described in patent application US 2007/0073030.

In U.S. Pat. No. 6,946,539, isosorbide is mentioned as possible initiator for preparing poly(trimethylene ether) glycol.

There is therefore a need to produce a chain extender that provides a solution to the abovementioned problems while still giving mechanical properties that are equivalent or superior to those obtained hitherto using commercially available chain extenders.

In the context of its research on polyalkoxylated compounds, the Applicant has developed a novel chain extender that surprisingly and unexpectedly improves the physical properties of polyurethane polymers, while solving the problems identified above.

Therefore, one subject of the invention is a composition characterized in that it comprises:
a compound of formula (I):

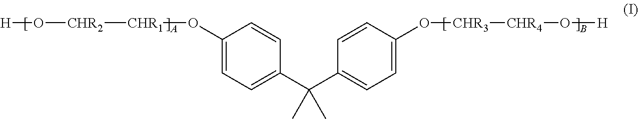

in which R₁, R₂, R₃ and R₄ are identical or different and represent, independently of one another, a hydrogen atom, a methyl radical or an ethyl radical and
A and B are identical or different and represent, independently of each other, a number between 0 and 10, it being understood that the sum A+B is greater than zero; and
a compound of formula (II):

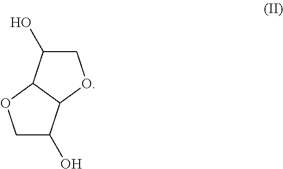

The compound of formula (II), i.e. isosorbide, is a product based on renewable raw materials such as, for example, sorbitol obtained from wheat starch, corn starch or potato starch.

In formula (I) as defined above, the radicals:

—O—CHR₂—CHR₁— and —CHR₃—CHR₄—O— represent more particularly, independently of each other, one of the following divalent radicals:
—O—CH₂—CH₂—, —CH₂—CH₂—O, —O—CH₂—CH(CH₃)—, —CH₂—CH(CH₃)—O—, —O—CH(CH₃)—CH₂—, CH(CH₃)—CH₂—O—, —O—CH(C₂H₅)—CH₂—, —CH(C₂H₅)—CH₂—O—, —O—CH₂—CH(CH₅)— or —CH₂—CH(C₂H₅)—O—.

Within each of the —[O—CHR₂—CHR₁]_{A}— and —[CHR₃—CHR₄—O]_{B}— groups, the —O—CH₂—CH₂—, —O—CH₂—CH(CH₃)—, —C—CH(CH₃)—CH₂—, —O—CH(C₂H₅)—CH₂—, —O—CH₂—CH(C₂H₅)—, —CH₂—CH₂—O, —CH₂—CH(CH₃)—O—, —CH(CH₃)—CH₂—O—, —CH(C₂H₅)—CH₂-0 and —CH₂—CH(C₂H₅)—O— radicals are distributed sequentially or randomly.

According to one more particular aspect, the subject of the invention is a composition characterized in that it consists, for 100% by weight, of a mixture of at least one compound of formula (I) and at least one compound of formula (II).

According to a particular aspect, the subject of the invention is a composition as defined above, for which R₁, R₂, R₃ and R₄ each represent a hydrogen atom in formula (I).

According to yet another particular aspect, the subject of the invention is a composition as defined above, comprising from 30% by weight to 90% by weight of the compound of formula (I) and from 10% by weight to 70% by weight of the compound of formula (II) and preferably containing from 45% by weight to 85% by weight of the compound of formula (I) and from 15% by weight to 55% by weight of the compound of formula (II).

Most particularly, the subject of the invention is a composition as defined above in which the compound of formula (I) is diethoxylated bisphenol A of formula (Ia):

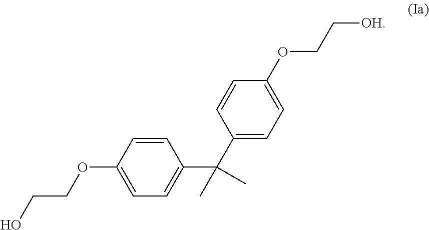

Preferably, the subject of the invention is a composition containing 50% by weight of the compound of formula (Ia) and 50% by weight of the compound of formula (II).

According to another aspect, the subject of the invention is also the use of the composition as defined above as chain extender in a polyurethane elastomer formulation.

Polyurethane elastomer materials are generally obtained by reaction between:
a diisocyanate, for example TDI (toluene diisocyanate), MDI (4,4′-diphenylmethane diisocyanate) or HDI (hexyl diisocyanate);
a long diol or a mixture of long diols, such as, for example, a polyether polyol, a polyester polyol, a polybutadiene polyol, a polypropylene glycol, a polyethylene glycol, a polytetramethylene glycol, a polycaprolactone or polyalcohols possessing active hydrogens;
a chain extender; and
a defoaming agent (for example, solutions of polysiloxane defoamers such as, for example, the products sold by BYK Chemie under the names BYK A506 and BYK A530); catalysts (for example, catalysts for OH/NCO reactions, such as trialkylamines (tetramethylbutanediamine, bis(2-dimethylaminoethyl)-ether, etc.); aliphatic polyamines; Mannich bases; diazabicyclooctane (DABCO); diazabicycloundecene (DBU); tin salts (tin octoate, dibutyltin laurate, etc.); mercury salts; zinc salts; lead salts; calcium salts; magnesium salts; N-alkylmorpholines; phosphines; carboxylates (magnesium carboxylate, potassium carboxylate, aluminum carboxylate, etc.); and mixtures of these various compounds) and other additives.

According to another aspect, the subject of the invention is also a process for preparing a polyurethane elastomer formulation from isocyanate prepolymers and an effective amount of a chain extender, characterized in that said chain extender is the composition as defined above. The expression “effective amount of a chain extender” is understood to mean between 5% and 30%, preferably between 10% and 20% and more preferably between 12% and 18% of a chain extender.

To obtain polyurethane elastomer materials, several different processes are possible:
a “one shot” process is conceivable, during which all the components mentioned above are added in a single step;
preferably, a process passing via a prepolymer is employed, involving a 2-step reaction. During the first step, the long diol or mixture of long diols is reacted with an excess of a diisocyanate in order to obtain a prepolymer possessing isocyanate functional groups.

It is preferred to use essentially linear diols which, with the exception of the hydroxyl groups at the ends, bear no other group that reacts with isocyanates. These diols have a molecular weight between 500 and 10 000 g/mol, preferably 700 and 5000 g/mol, with special preference for the range from 1000 to 3000 g/mol. The molecular weight is understood to mean the average molecular weight. Preferably, polyesters, polyether glycols, polyalkylene glycols, for example polyethylene glycol, polypropylene glycol and/or polytetramethylene glycol, are used. Polytetramethylene glycol, also known as polytetrahydrofuran, may be produced by the ionic polymerization of tetrahydrofuran with acid catalysts. Suitable copolymers are also obtained by polymerizing tetrahydrofuran with a mixture of propylene oxide, ethylene oxide and glycols.

This process is one of the more widely used processes and many commercial prepolymers have been proposed such as, for example, VIBRATHANE™ sold by Chemtura, BAYTEC™ sold by Bayer, SUPRASEC™ sold by Huntsman, LUPRANATE™ sold by BASF, etc. An isocyanate prepolymer is characterized by its NCO content;
the “quasi prepolymer” process is similar to the “prepolymer” process, but in this case only some of the long diol is reacted, and not all of it.

According to another aspect, the subject of the invention is the use of the composition as defined above, as monomer in the preparation of saturated or unsaturated polyesters, the preparation of polycarbonates or the preparation of epoxy resins.

The following description illustrates the invention without however limiting it.

The mixtures mentioned below were prepared in the following manner:
the compound of formula (II) was melted at 65-70° C.;
the compound of formula (I) was progressively added, the mixtures being heated to 90-95° C. for better homogenization—all the mixtures were clear and homogeneous at 95° C.;
the mixtures were dried; and
the homogeneity of the mixture (compatibility of the two compounds) was observed.

The characteristics of the three compositions according to the invention thus prepared are given in Table 1 below:

TABLE 1

| | Trial No. | | | | |
|---|---|---|---|---|---|
| | Compound I/ | | | | |
| | 1,4-Butanediol | Compound I/ | | Compound I/ | Compound I/ |
| | (50/50) | Compound II | | Compound II | Compound II |
| | Comparative | (50/50) | | (70/30) | (80/20) |
| | Composition 0 | Composition 1 | | Composition 2 | Composition 3 |
| Mass ratio (%) | 50/50 | 50/50 | | 70/30 | 80/20 |
| Molar ratio (%) | 22/78 | 31.2/68.8 | | 51.5/48.5 | 64.5/35.5 |
| Average MW of the | 140.5 | 200.5 | | 235.7 | 258.3 |
| mixture (g/mol) | | | | | |
| I OH of the mixture | 798.6 | 559.5 | | 476.1 | 434.4 |
| (by calculation) | | | | | |
| in mg KOH/g | | | | | |
| Appearance at 25° C. | Solid | Supercooled | | Solid | Solid |
| | | liquid | | | |
| at 40° C. | Solid | Homogeneous | | Solid | Solid |
| | | liquid | | | |
| at 60° C. | Solid | Homogeneous | | Homogeneous | Solid |
| | | liquid | | liquid | |
| at 80° C. | Liquid | Homogeneous | | Homogeneous | Homogeneous |
| | | liquid | | liquid | liquid |
| LVT viscosity at 25° C. | — | 11 280 | cPs | — | — |
| at 40° C. | — | 2150 | cPs | — | — |
| at 60° C. | — | 1050 | cPs | 775 cPs | — |
| at 80° C. | 24 cPs | 252 | cPs | 160 cPs | 213 cPs |
| Melting point of the | <80° C. | <80° | C. | 87° C. | 96° C. |
| mixture measured | | | | | |
| on a Mettler FP 300 | | | | | |

Next, 6 polyurethane elastomer compositions were prepared, the parameters of which are given in Table 2 below, from:
VIBRATHANE™ B625, sold by Chemtura, which is an isocyanate prepolymer having a percentage isocyanate (—N—C═O) content of between 6.2 and 6.9;
a chain extender according to the invention, corresponding to Compositions 1 to 3 of Table 1 in respect of Formulations 3 to 5 respectively; and
a chain extender according to the prior art: 1,4-butanediol in respect of Formulation 1; a composition E comprising 52% diethoxylated resorcinol by weight and 48% diethoxylated bisphenol A by weight in respect of Formulation 2; and composition 0 in respect of Formulation 0.

The following results are also in agreement with processes employing other isocyanate prepolymers than VIBRATHANE™, other diisocyanates and other long diols, such as those described above.

The operating method to be followed in order to synthesize these elastomers was the following:
1. heat the prepolymer to a temperature of 85° C. and then degas it;
2. prepare the molds by coating them with a mold release agent and place them in an oven at a temperature of 120° C.;
3. prepare a prior water content of the chain extender (if the water content is greater than 800 ppm, the chain extender must be dehydrated);
4. heat the diol/triol mixture at 85° C. and then degas it;
5. weigh out the amount of prepolymer necessary for the trial in a beaker, add the BYK A530 defoaming agent and finally add the exact amount of chain extender;
6. mix (stirring time: 30 seconds; stirring speed: 1000 rpm; the blade type for the various mixtures always remaining the same);
7. place the beaker in the vacuum bell; start to degas the mixture; remove the molds from the oven and immediately pour the mixture into them;
8. place the filled molds in the oven at a temperature of 120° C.; observe the behavior of the product remaining in the beaker and observe the pot life;
9. demold, depending on the chain extender, and then observe whether the sheet is cured or not; put the sheet back into the oven for postcuring; and
10. remove the sheet from the oven and leave it to age (mature) before the physical tests according to the existing ISO standards are carried out.

TABLE 2

| | Formulation 1 | | Formulation 2 | | Formulation 3 | | Formulation 4 | | Formulation 5 | | Formulation 0 | |
|---|---|---|---|---|---|---|---|---|---|---|---|---|
| | (comparison) | | (comparison) | | (invention) | | (invention) | | (invention) | | (comparison) | |
| Formulation | | | | | | | | | | | | |
| Vibrathane (% NCO: 6029) | 100 | g | 100 | g | 100 | g | 100 | g | 100 | g | 100 | g |
| Vibrathane (% NCO: 6029) | | | | | | | | | | | | |
| 1,4-Butanediol | 6.41 | g | 0 | | 0 | | 0 | | 0 | | 5.07 | g |
| Composition E | 0 | | 7.39 | g | | | | | | | | |
| Compound I | 0 | | 3.55 | g | 7.23 | g | 11.9 | g | 14.91 | g | 0 | |
| Compound II | 0 | | 0 | | 7.23 | g | 5.1 | g | 3.72 | g | 5.07 | g |
| BYK ™ A 530 | 0.5 | g | 0.5 | g | 0.5 | g | 0.5 | g | 0.5 | g | 0.5 | g |
| (defoaming agent) | | | | | | | | | | | | |
| Pot life | 6 | minutes | 21 | minutes | 8 | minutes | 8 | minutes | 8 | minutes | 9 | minutes |
| Process parameters | | | | | | | | | | | | |
| Prepolymer temperature | 85° | C. | 85° | C. | 85° | C. | 85° | C. | 85° | C. | 85° | C. |
| Extender temperature | 85° | C. | 85° | C. | 85° | C. | 85° | C. | 85° | C. | 95° | C. |
| Curing temperature | 120° | C. | 120° | C. | 120° | C. | 120° | C. | 120° | C. | 120° | C. |
| Stirring time | 30 | minutes | 30 | minutes | 30 | minutes | 30 | minutes | 30 | minutes | 30 | minutes |
| Curing time | 4 | hours | 4 | hours | 4 | hours | 4 | hours | 4 | hours | 4 | hours |
| Postcuring time | 16 | hours | 16 | hours | 16 | hours | 16 | hours | 16 | hours | 16 | hours |
| Maturation time | 6 | days | 6 | days | 6 | days | 6 | days | 6 | days | 6 | days |

| | | | | | | |
|---|---|---|---|---|---|---|
| Visual appearance of the | opaque | opaque | transparent | transparent | transparent | opaque |
| final formulation | | | | | | |

Pot life: time during which the mixture can be used without its viscosity increasing substantially.

The mechanical properties of each of Formulations 1 to 5 were measured and the results are given in Table 3 below:

TABLE 3

| | | | Formulation 2 | | Formulation 3 | | Formulation 4 | | Formulation 5 | | Formulation 0 | |
|---|---|---|---|---|---|---|---|---|---|---|---|---|
| | Formulation 1 | | (comparison) | | (invention) | | (invention) | | (invention) | | (comparison) | |
| Hardness | 84 | | 87 | | 84 | | 78 | | 73 | | 82.5 | |
| (ISO 868 standard) | | | | | | | | | | | | |
| Tensile properties | 6.15 | MPa | 7.34 | MPa | 5.47 | MPa | 3.14 | MPa | 2.59 | MPa | 5.08 | MPa |
| (ISO 37 standard): | | | | | | | | | | | | |
| Stress at 100% | | | | | | | | | | | | |
| Tensile properties | 9.16 | MPa | 10.11 | MPa | 8.06 | MPa | 4.94 | MPa | 4.68 | MPa | 8.12 | MPa |
| (ISO 37 standard): | | | | | | | | | | | | |
| Stress at 200% | | | | | | | | | | | | |
| Tensile properties | 12.78 | MPa | 12.93 | MPa | 11.2 | MPa | 8.41 | MPa | 9.2 | MPa | 13.9 | MPa |
| (ISO 37 standard): | | | | | | | | | | | | |
| Stress at 300% | | | | | | | | | | | | |
| Tensile properties | 20.01 | MPa | 18.15 | MPa | 18.15 | MPa | 24.30 | MPa | 14.68 | MPa | 16.4 | MPa |
| (ISO 37 standard): | | | | | | | | | | | | |
| Tensile strength | | | | | | | | | | | | |
| Tensile properties | 450% | | 485% | | 460% | | 430% | | 380% | | 325% | |
| (ISO 37 standard): | | | | | | | | | | | | |
| Elongation at break | | | | | | | | | | | | |
| Tensile properties | 16.88 | MPa | 22.15 | MPa | 23.81 | MPa | 18.34 | MPa | 9.94 | MPa | 13.80 | MPa |
| (ISO 37 standard): | | | | | | | | | | | | |
| Young's modulus | | | | | | | | | | | | |
| Tear strength | 44.43 | kN/m | 69.63 | kN/m | 63.72 | kN/m | 56.80 | kN/m | 38.81 | kN/m | 48.3 | kN/m |
| (ISO 34 standard) | | | | | | | | | | | | |

| | | | | | | |
|---|---|---|---|---|---|---|
| Vertical rebound | 54 | — | 45 | 41 | 37 | 50 |
| (ASTM D2632) | | | | | | |

These results clearly bring out the advantages in using the chain extenders according to the invention compared with composition E and with 1,4-butanediol, products used up till now for this function.

Specifically, the compound I/compound II mixtures according to the invention, when used as chain extenders, result in transparent materials.

In addition, they are based, in part, on renewable raw materials.

In particular, the compound I/compound II (50/50 wt %) mixture makes it possible to obtain a transparent material with mechanical properties similar or even superior to the commercial reference material, namely 1,4-butanediol. Furthermore, at least 50% of this mixture comprises renewable substances. The materials obtained with this mixture have a 30% higher tear strength than the materials obtained with a chain extender such as 1,4-butanediol.

Unexpectedly, other advantages are revealed by using compositions according to the invention as chain extenders in an elastomer formulation. For example, by incorporating isosorbide with a compound of formula I it is possible to lower the melting point in the temperature range of use of chain extenders (mixing temperature=80° C.): for the 50/50 mixture, we obtain a melting point below 80° C., the temperature of use of the chain extenders.

The incorporation of a diol such as isosorbide with a compound of formula I in a polyurethane elastomer formulation enables the mechanical properties of the elastomer to be substantially increased. The performance of the compound I/compound II mixture is very close to that obtained with just isosorbide.

The use of a mixture of chain extenders having an aromatic structure makes it possible to provide the synthesized polyurethane elastomer with good thermal aging and hydrolytic resistance.

The elastomers produced with the compound I/compound II mixtures are all transparent. It may prove to be beneficial to use these mixtures as chain extenders in a polyurethane hot-melt adhesive application.

1. A composition comprising:
from 30% by weight to 90% by weight of a compound of formula (I): 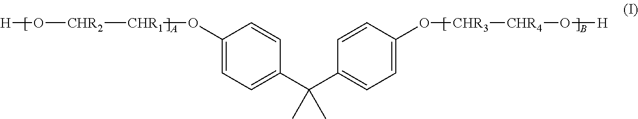
in which R₁, R₂, R₃ and R₄ are identical or different and represent, independently of one another, a hydrogen atom, a methyl radical or an ethyl radical and
A and B are identical or different and represent, independently of each other, a number between 0 and 10, it being understood that the sum A+B is greater than zero; and
from 10% by weight to 70% by weight of an isosorbide compound of formula (II):

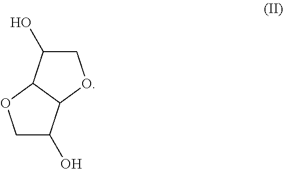

2. The composition as defined in claim 1, wherein R₁, R₂, R₃ and R₄ each represent a hydrogen atom in formula (I).

3. The composition as defined in claim 1, comprising from 45% by weight to 85% by weight of the compound of formula (I) and from 15% by weight to 55% by weight of the isosorbide compound of formula (II).

4. The composition as defined in claim 1, wherein the compound of formula (I) is diethoxylated bisphenol A of formula (Ia):

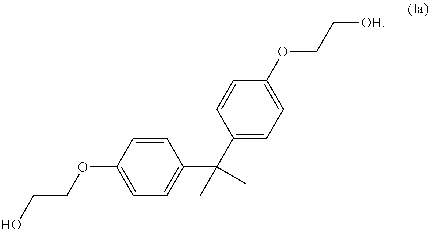

5. The composition as defined in claim 4, comprising 50% by weight of the compound of formula (Ia) and 50% by weight of the isosorbide compound of formula (II).

6. A method of preparing a composition as defined in claim 1, comprising the following steps:
step a) in which the isosorbide compound of formula (II) is melted;
step b) in which the compound of formula (I) is progressively added to the isosorbide compound of formula (II) resulting from step a); and
step c) in which the mixtures resulting from step b) are dried.

7. A process for preparing a polyurethane elastomer formulation, comprising reacting prepolymers with a chain extender, wherein said chain extender is the composition defined in claim 1.

8. A process for preparing a polyurethane elastomer formulation from isocyanate prepolymers and an effective amount of a chain extender, comprising reacting said isocyanate prepolymers with said chain extender, wherein said chain extender is the composition as defined in claim 1.

9. A process of preparing saturated or unsaturated polyesters, polycarbonates or epoxy resins, comprising a reaction, wherein the composition defined in claim 1 is used as a monomer.

10. A polyurethane elastomer comprising a chain extender, wherein said chain extender is the composition as defined in claim 1.
